(19) United States
(12) Patent Application Publication
(10) Pub. No.: US 2014/0153269 A1
(43) Pub. Date: Jun. 5, 2014

(54) Vehicle Auxiliary Lighting System

(71) Applicant: Yao Hung Huang, Rende Township (TW)

(72) Inventor: Yao Hung Huang, Rende Township (TW)

(21) Appl. No.: 13/693,777

(22) Filed: Dec. 4, 2012

(51) Int. Cl. B60Q 1/52

(52) U.S. Cl. CPC B60Q 1/52
USPC 362/464

(57) ABSTRACT

A vehicle auxiliary lighting system (VALS) that is designed to have installed on the lower inner edge of a vehicle's rear-facing, upward-opening door a set of rear facing lights. When the rear door is lifted, the lights are manually or automatically activated and produce a light beam that can easily be viewed by oncoming vehicular traffic. The illuminated light provides an extra margin of safety to personnel attending to a disabled vehicle that has been parked adjacent a road.

### TECHNICAL FIELD

The invention generally pertains to vehicle lights, and more particularly to a vehicle auxiliary lighting system (VALS) that incorporates a set of lights located on the lower-inner edge of a vehicle's upward-opening rear door. When the door is lifted, the lights are positioned to produce a beam that is easily seen by oncoming vehicular traffic.

### BACKGROUND ART

All vehicles that have upward-opening rear doors, such as SUVs and Vans, are required by law to have a set of at least two rear-facing lights and a third rear window light. When a vehicle is disabled and is parked along the side of a street or highway, the rear lights are activated to warn the drivers of oncoming vehicles that they are approaching a potentially dangerous obstruction. The activation of the rear lights is especially important during the night time when vision is impaired.

The problem with activating the current rear lights is that in most vehicles the lights are typically, located a short distance from ground level. At this distance the lights can be easily obscured by road structures or by persons attempting to render aid. The instant invention solves or at least minimizes the problem of light obstructions by adding a set of lights that are located on the lower-inner edge of the upward-opening door. When the door is lifted upward the lights are at a higher level, allowing the lights to overcome the obstructions and to produce a beam that is easily viewed by drivers of oncoming vehicles.

A search of the prior art did not disclose any literature or patents that read directly on the claims of the instant invention.

### DISCLOSURE OF THE INVENTION

The vehicle auxiliary lighting system (VALS) is designed to provide an additional margin of safety by adding a pair of rear-viewing lights to a vehicle. The lights are attached to an inner edge of a vehicle's rear facing cargo door or the like. When the rear door is lifted, the attached lights are positioned above the vehicle's normal tail lights, thereby making the lights easier to see from a greater distance. This provides an additional margin of safety to persons attending to a parked, disabled vehicle. In its basic design configuration, the VALS is comprised of:

a) at least one light having means for being attached to the lower inner edge of a vehicle's rear facing door,

b) means for attaching the at least one light to the rear door, and

c) means for activating the at least one light.

The at least one light is preferably comprised of two horizontally attached lights that can consist of either incandescent lights, fluorescent lights or a cluster of LEDs that are selected to produce either a red or amber color. The lights activating means utilizes a set of switches S1-S3. The switch S1 is located in the driver's compartment so that it can be closed by the driver before exiting the vehicle. The remaining two switches S2 and S3, are attached to the vehicle's rear door.

The VALS can also be designed to include a tilt switch S4 which is also attached to the rear door. If the tilt switch is installed, the switches S3 and S3 are not required as the lights will illuminate automatically when the rear door is lifted. However, if only the tilt switch is used, the rear door lights will automatically illuminate even if the lights are not needed or wanted. To preclude this problem, the tilt stich can be connected in series with the first switch S1 that is located in the driver's compartment. In this case, the rear lights would illuminate when the rear door is opened, only if the driver first closes the first switch S1.

In view of the above disclosure, the primary object of the invention is to produce a VALS that includes a set of lights that are attached to the inner lower edge of a vehicle's upper lifting door. When the door is lifted, the lights illuminate, producing a light beam that is visible to oncoming traffic.

In addition to the primary object of the invention it is also an object of the invention to produce a VALS that:
can be produced as an OEM product or as an after market product,
can be purchased as a kit,
can potentially reduce insurance fees,
is easily installed,
is reliable and relatively maintenance free
can be used with various upward-lifting door designs,
adds value to a vehicle, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a rear elevational view of a vehicle's rear-facing upward-opening rear door showing a left light and a right light attached to the lower inner edge of the vehicle's door.

FIG. 2 is a block diagram of a first light activating circuit.

FIG. 3 is a block diagram of a second light activating circuit.

FIG. 4 is a block diagram of a third light activating circuit.

### BEST MODE FOR CARRYING OUT THE INVENTION

The best mode for carrying out the invention is presented in terms that disclose a preferred embodiment of a vehicle auxiliary lighting system (VALS). The VALS utilizes at least two rear facing lights that are located on a lower inner edge of a vehicle's rear-facing, upward-opening door. When the rear door is lifted, the two lights are activated and produce a beam that faces oncoming vehicular traffic.

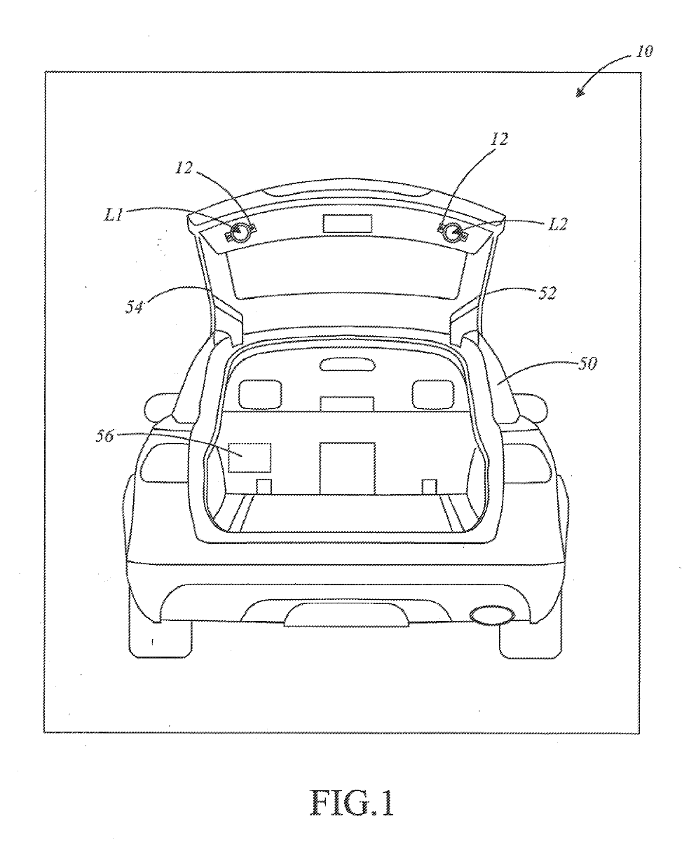

The preferred embodiment of the VALS 10, as shown in FIGS. 1-4, operates in combination with a vehicle 50 which is equipped with a rear-facing upward-opening door 52 that includes a lower-inner edge 54, and a vehicle power source 56. The vehicle supplied elements function in combination with the following inventive elements: a light-attaching bracket 12, a fuse F1, at least one first light L1 and preferably a first light L1 and a second light L2, a first switch S1, a second switch S2, a third switch S3 and a fourth switch S4. The switches S1-S3 are single-pole, single-throw toggle switches (SPST) and the switch S4 is a tilt switch.

The light-attaching bracket 12 is designed to be attached to the lower inner edge of the rear door 52. The bracket 12 is designed to allow the interface of the bracket 12 to accommodate the structure of a particular vehicle's rear lifting door. The vehicle's rear door 52 can consist of a cargo door, a hatchback door or a vertically lifted door.

The vehicle power source 56 typically produces 12-volt d-c which is provided by the vehicle battery. The input of the power into the VALS 10 is taken from a location that produces a constant 12-volt d-c, that is, a location in the vehicle 50 that has power available at all times. This allows the lights L1,L2 to be activated under any condition. Optionally, the power source 56 can be taken from a circuit that is attached to the vehicle's “emergency flasher” which would then allow the lights L1,L2 to blink ON and Off in concert with the blinking rate produced by the vehicle's light blinking unit.

The VALS 10 is designed to utilize a light activation circuit that can be implemented in various design configurations without affecting the primary object of the invention which is, to produce a pair of lights that can be easily seen by oncoming vehicular traffic. Three designs configurations are disclosed: a first light activation circuit 14, a second light activation circuit 16 and a third light activation circuit 18.

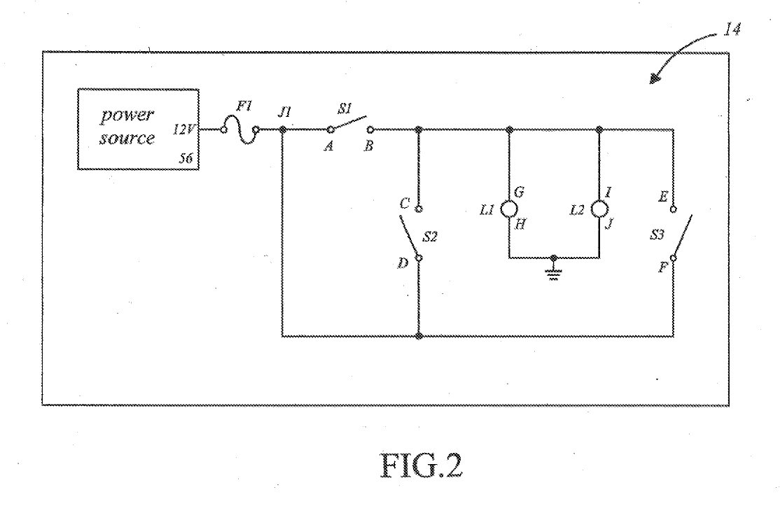

The first light activation circuit 14, as shown in FIG. 2, is comprised of a first switch S1, a second switch S2, a third switch S3, a left light L1 and a right light L2.

The first switch S1 has a contact A and a contact B, wherein the contact A is connected to the vehicle power source through a fuse F1.

The second switch S2 has a contact C and a contact D, wherein the contact C is connected to the contact B on the switch SI, and the contact D is connected to a junction J1 that is located between the fuse Fl and the contact A of the switch S1.

The third switch S3 has a contact E and a contact F, wherein the contact E is connected to the contact B on the switch S1, and contact F is connected to the junction J1.

The left light L1 has a contact G and a contact H, wherein the contact G is connected to the contact B on the first switch S1, and the contact H is connected to circuit ground, and

The right light L2 has a contact I and a contact J, wherein the contact I is connected to the contact B on the switch S1, and the contact J is connected to circuit ground.

The operational sequence produced by the first light activating circuit 14, as shown in FIG. 2, to control the activation of the lights L1 and L2 is as follows: O=open, C=closed.

| S1 | S2 | S3 | L1 | L2 |
|---|---|---|---|---|
| O | O | O | OFF | OFF |
| C | O | O | ON | ON |
| O | C | O | ON | ON |
| O | O | C | ON | ON |

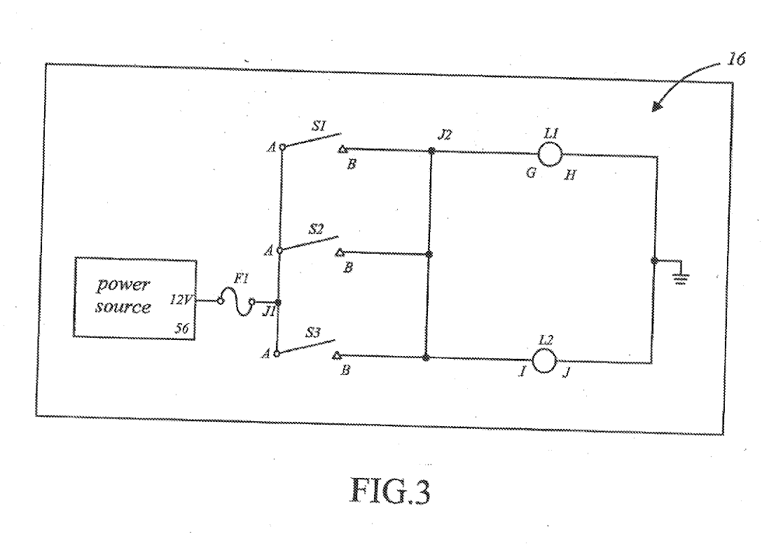

The second light activation circuit 16, as shown in FIG. 3, is comprised of a first switch S1, a second switch S2, a third switch S3, a first light L1 and a second light L2.

The switches S1-S3 are connected in parallel with each switch having a contact A and a contact B, the contacts A are attached to a junction J1 that is connected to the vehicle power source through a fuse F1, and the contacts B are connected in parallel to a junction J2.

The left light L1 has a contact G and a contact H, wherein the contact G is connected to the junction J2, and

The right light L2 has a contact I and a contact J, wherein the contact I is connected to the junction J2, and the contact J is connected to circuit ground.

The operational sequence provided by the second light activation circuit 16, as shown in FIG. 3, to control the activation of the lights L1 and L2 are as follows: O=open, C=closed.

| S1 | S2 | S3 | L1 | L2 |
|---|---|---|---|---|
| O | O | O | OFF | OFF |
| C | O | O | ON | ON |
| O | C | O | ON | ON |
| O | O | C | ON | ON |

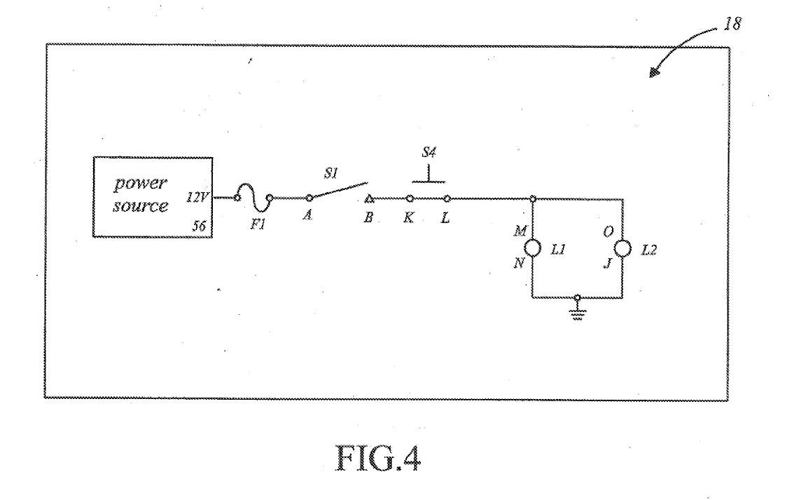

The third light activation circuit 18, as shown in FIG. 4, is comprised of a first switch S1, a tilt switch S4, a light L1 and a light L2.

The switch S1 has a contact A and a contact B, wherein the contact A is connected to the vehicle power source through a fuse F1.

The switch S4 has a contact K and a contact L, wherein the contact K is connected in series to contact B on the switch S1,

The left light L1 has a contact M and a contact N, wherein the contact M is connected to contact L on the switch S4, and contact N is connected to circuit ground, and

The right light L2 has a contact O and a contact P, wherein the contact O is connected to contact M on the light L1, and the contact P is connected to circuit ground.

The operational sequence provided by the third light activated circuit 18, as shown in FIG. 4, controls the activation of the lights L1 and L2 is as follows: O=open, C=closed.

| S1 | S4 | L1 | L2 |
|---|---|---|---|
| O | C | OFF | OFF |
| C | O | OFF | OFF |
| C | C | ON | ON |

While the invention has been described in detail and pictorially shown in the accompanying drawing sit is not to be limited to such details, since many changes and modification may be made to the invention without departing from the spirit and the scope thereof. For example, other light activating circuits can be designed to activate the lights L1 and L2. However the primary object of the VALS 10 remains which is to provide an extra margin of safety that can prevent an inadvertent collision with a disabled vehicle 50. Hence, it is described to cover any and all modifications and forms which may come within the language and scope of the claims.

1. A vehicle auxiliary lighting system (VALS) that functions in combination with a vehicle's upward-opening rear door having a lower inner edge, and a vehicle power source, said VALS comprising:
a) at least one light having means for being attached to the lower inner edge of the vehicle's rear door,
b) means for attaching said at least one light to the rear door, and
c) means for activating said at least one light, wherein when the vehicle is disabled the activated said lights produce a beam that is visible to oncoming vehicular traffic which provides an extra margin of safety.

2. The VALS as specified in claim 1 wherein said means for attaching said at least one light to the vehicle's rear door comprises a bracket designed to allow the interface of the bracket to accommodate a particular vehicle rear door.

3. The VALS as, specified in claim 2 wherein said light is further comprised of at least a left light and a right light.

4. The VALS as specified in claim 3 wherein said left and right lights are selected from the group consisting of LEDS, incandescent lights and fluorescent lights.

5. The VALS as specified in claim 4 wherein said LEDS are comprised of a cluster of LEDS.

6. The VALS as specified in claim 5 wherein said cluster of LEDS are selected to provide a red light or an amber light.

7. The VALS as specified in claim 1 wherein the vehicle power source is taken from a constant 12-volt d-c power source.

8. The VALS as specified in claim 3 wherein the vehicle power source is provided from the vehicle's emergency flasher circuit.

9. The VALS as specified in claim 3 wherein said means for activating said lights is provided by a first light activating circuit comprising:
a) a first switch (S1) having a contact (A) and a contact (B), wherein the contact (A) is connected to the vehicle power source through a fuse (F1),
b) a second switch (S2) having a contact (C) and a contact (D), wherein the contact (C) is connected to the contact (B) on said switch (S1), and the contact (D) is connected to a junction (J1) located between said fuse (F1) and the contact (A) of said switch (S1),
c) the third switch (S3) has a contact (E) and a contact (F), wherein the contact (E) is connected to the contact (B) on said switch (S1), and contact (F) is connected to the junction (J1),
d) the left light (L1) has a contact (G) and a contact (H), wherein the contact (G) is connected to the contact (B) on the first switch (S1), and the contact (H) is connected to circuit ground, and
e) the right light (L2) has a contact (I) and a contact (J), wherein the contact (F) is connected to the contact (B) on the switch (S1), and the contact (J) is connected to circuit ground.

10. The VALS as specified in claim 9 wherein said switch (S1) is located in the vehicle driver's compartment and said switches (S2 and S3) are located adjacent the vehicle's rear door.

11. The VALS as specified in claim 3 wherein said means for activating said lights utilizes is provided by a second light activation circuit comprising:
a) the switches (S1-S3) are connected in parallel with each switch having a contact (A) and a contact (B), wherein the contacts (A) are attached to a junction (J1) that is connected to the vehicle power source through a fuse (F1), and the contacts (B) are connected in parallel to a junction (J2),
b) a left light (L1) having a contact (G) and a contact (H), wherein the contact (G) is connected to the junction (J2), and
c) a right light (L2) having a contact (I) and a contact (J), wherein the contact (I) is connected to the junction (J2), and the contact (J) is connected to circuit ground.

12. The VALS as specified in claim 11 wherein said switches (S1-S3) are comprised of single-pole, single-throw toggle switches or push ON/push OFF switches.

13. The VALS as specified in claim 12 wherein said light (L1,L2) are selected from the group consisting of LED lights, incandescent lights and fluorescent lights.

14. The VALS as specified in claim 3 wherein said means for activating said lights is provided by a third light activation circuit comprising:
a) a switch (S1) has a contact (A) and a contact (B), wherein the contact (A) is connected to the vehicle power source through a fuse (F1),
b) a switch (S4) has a contact (K) and a contact (L), wherein the contact (K) is connected in series to contact (B) on the switch (S1),
c) a left light (L1) has a contact (M) and a contact (N), wherein the contact (M) is connected to contact (L) on the switch (S4), and contact (N) is connected to circuit ground, and
d) a right light (L2) has a contact (O) and a contact (P), wherein the contact (O) is connected to contact (M) on the light (L1), and the contact (P) is connected to circuit ground.

15. The VALS as specified in claim 14 wherein said switch (S1) is comprised of single-pole, single-throw toggle switches and switch (S4) is comprised of a tilt switch.

16. The VALS as specified in claim 15 wherein said left and right lights are selected from the group consisting of LED lights, incandescent lights and fluorescent lights.

17. The VALS as specified in claim 16 wherein said LED lights are comprised of a cluster of LEDS.

18. The VALS as specified in claim 17 wherein said cluster of LEDS are selected to provide a red light or an amber light.
